(19) United States
(12) Patent Application Publication
(10) Pub. No.: US 2012/0196751 A1
(43) Pub. Date: Aug. 2, 2012

(54) ANTHRAQUINONE CONTAINING PREPARATIONS/LIGNIN FORMULATIONS

(75) Inventors: James Namnath, Davis, CA (US); Hai Su, Woodland, CA (US)

(73) Assignee: MARRONE BIO INNOVATIONS, INC., Davis, CA (US)

(21) Appl. No.: 13/364,400

(22) Filed: Feb. 2, 2012

Related U.S. Application Data
(60) Provisional application No. 61/438,796, filed on Feb. 2, 2011.

(51) Int. Cl. A01N 43/16; A01P 21/00; A01P 3/00; A01N 35/06; A01P 1/00

(52) U.S. Cl. 504/292; 504/348; 514/33; 514/680

(57) ABSTRACT

Provided is a formulation comprising (a) a preparation comprising one or more anthraquinone derivatives having activity against plant pests and (b) a lignin. Also provided is a method for obtaining the formulation and for using the formulation to modulate phytopathogenic, fungal and/or bacterial infection and/or plant pest infestation.

### TECHNICAL FIELD

Disclosed herein are formulations, particularly, plant preparations containing anthraquinone derivatives and lignin.

### BACKGROUND

With the rapid spread of resistance of plant pathogen populations to synthetic fungicides and increased awareness of human to environmental pollution, an alternative means of control plant diseases is very necessary. The most effective means is to boost the plant defense mechanisms by induced plant resistance (van Loon et al., 1998) and/or systemic acquired resistance (Durant et al., 2004).

Induced resistance is a state of enhanced defensive capacity developed by a plant when appropriately stimulated (Kuc et al., 2000). Induced plant resistance can be triggered by chemicals, nonpathogens, avirulent forms of pathogens.

Reynoutria sachalinensis extract

Extract from giant knotweed (Reynoutria sachalinensis) sold as Milsana® and Regalia® by Marrone Bio Innovations, Inc. provides control of powdery mildew and other plant diseases on cucurbits and other crops mainly by inducing an accumulation of fungitoxic phenolic compounds in the plant (Daayf et al., 1995; Wurms et al. 1999; Schmitt, 2002). Formulated giant knotweed extract has also shown great efficiency in inducing resistance in various crops and plant pathogens including wheat powdery mildew (V\check{e}chet et al., 2009). Besides the ISR mode of action, the formulated R. sachalinensis extract has recently also been shown to have a direct fungistatic effect against wheat powdery mildew (Blumeria graminis f. sp. tritici; Randoux et al., 2008). These extracts have been found to contain various anthraquinone derivatives such as physcion and emodin.

### Lignin

Lignin is a principal constituent of the woody structure of higher plants. Processed lignin is obtained as a by-product of wood pulping reactions. Lignin products include, for example, lignin sulphonates, alkali lignins, and oxylignins which may be obtained from sulphite, sulphate, and alkali waste liquors (Snook, 1982, Handbook for Pulp & Paper Technologists, TAPPI, Atlanta).

Lignin has been found to have a variety of commercial uses. For example, alkali soluble lignin has been used as a dispersing agent. U.S. Pat. No. 3,726,850 discloses the use of an alkali soluble, ozone-treated lignin product, which is essentially free of organically bound sulfur, as a dispersing agent for clays, dyestuffs, pesticides, carbon black and other materials. U.S. Pat. No. 4,666,522 discloses the use of lignosulphonate products for preparing emulsions of waxes, oils, fats, asphalts, and mixtures thereof. Lignin acetate, has been reported to be useful for applications such as acting as a binder in water-based printing ink compositions. (See, e.g., U.S. Pat. No. 4,612,051). U.S. Pat. No. 5,668,183 discloses the use of lignin sulphonate products for dispersing fat-soluble substances. Furthermore, there have been disclosures of binding of lignin-pesticide complexes (see, for example, U.S. Pat. No. 3,813,236, U.S. Pat. No. 3,929,453, reissued as Re. No. 29,238, U.S. Pat. No. 4,381,194, US Patent Application Pub. No. 20110015237, US Patent Application Pub. No. 2010136132, US Patent Application Pub. No. 20100278890, US Patent Application Pub. No. 20080113920, US Patent Application Pub. No. 2006247130, U.S. Pat. No. 7,867,507, WO2003/005816, U.S. Pat. No. 5,994,266).

### SUMMARY OF DISCLOSURE

Provided is a formulation comprising (a) a preparation comprising one or more anthraquinone derivatives having activity against plant pests and (b) a lignin. The formulation may be a dry formulation or aqueous formulation. In particular, the preparation may be a Reynoutria extract and the lignin may be a lignin sulphonate, particularly a lignin sulphonate salt.

Further provided is a method for obtaining the formulation comprising: mixing (a) a preparation comprising one or more anthraquinone derivatives having activity against plant pests with (b) a lignin to in particular obtain a dry formulation. The method may further comprise mixing the dry formulation with water.

Also provided is a method for of using these formulations for
(1) modulating phytopathogenic, fungal and/or bacterial infection and/or plant pest infestation and/or
(2) modulating seed germination and/or
(3) modulating growth of a plant
   comprising treating the plant and/or seed with effective amounts of the formulation to modulate phytopathogenic, fungal and/or bacterial infection and/or plant pest infestation and/or to modulate seed germination and/or modulate growth of said plant. A seed coating agent may optionally be included as well.

### DETAILED DESCRIPTION OF DISCLOSURE

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise. For example, “a fungus” also encompasses “fungi”.

As defined herein, the term “modulate” is used to mean to alter the amount of phytopathogenic, bacterial or fungal infection, plant pest infestation or rate of spread of phytopathogenic bacterial or fungal infection or plant pest infestation. The term “modulate” is also used to mean to alter the amount of growth and preferably increase the amount or rate of growth or germination of a seed of a plant.

### Anthraquinone Derivatives

Anthraquinone derivatives include, but are not limited to, physcion, emodin, chrysophanol, ventiloquinone, emodin glycoside, chrysophanol glycoside, physcion glycoside, 3,4-dihydroxy-1-methoxy anthraquinone-2-corboxaldehyde, damnacanthal. These derivatives share a similar structure as follows:

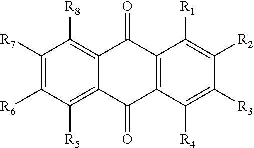

Where R1, R2, R3, R4, R5, R6, R7 and R8 are hydrogen, hydroxyl, hydroxylalkyl, halogen, carboxyl, alkyl, alkyoxyl, alkenyl, alkenyloxyl, alkynyl, alkynyloxyl, heterocyclyl, aromatic, or aryl group, sugars such as glucose.

In a particular embodiment, the invention is directed to anthraquinone derivatives that are contained in extracts derived from plant families including but not limited to Polygonaceae, Rhamnaceae, Fabaceae, Asphodelaceae, and Rubiaceae. These compounds can be isolated or obtained from any part of plants such as leaf, stem, bark, root and fruits. Plant materials can be wet and dry, but preferably dry plant materials. To be classified as an organically listed biochemical biopesticide, solvents and processes that are used in the extraction and purification must meet the requirements of National Organic Program (NOP) (www.ams.usda.gov/AMSv1.0/nop).

In a more particular embodiment, the plant extract is derived from a member of the Polygonaceae family. As defined herein, “derived from” means directly isolated or obtained from a particular source or alternatively having identifying characteristics of a substance or organism isolated or obtained from a particular source. In a particular embodiment, extract in said combination contains at least one anthraquinone derivative such as physcion and optionally emodin. Members of the Polygonaceae family include but are not limited to Acetosella, Antigonon, Aristocapsa, Bilderdykia, Brunnichia, Centrostegia, Chorizanthe, Coccoloba, Coccolobis, Coccolobo, Corculum, Dedeckera, Delopyrum, Dentoceras, Dodecahema, Emex, Eriogonum, Fafopyrum, Fagopyrum, Fallopia, Gilmania, Goodmania, Harfordia, Hollisteria, Koenigia, Lastarriaea, Mucronea, Muehlenbeckia, Nemacaulis, Oxyria, Oxytheca, Perscarioa, Persicaria, Pleuropterus, Podopterus, Polygonella, Polygonum, Pterostegia, Rheum, Rumex, Ruprechtia, Steno gonum, Systenotheca, Thysanella, Tovara, Tracaulon, Triplaris and even more particular embodiment, the extract may be derived from a Reynoutria (alternately referred to as Fallopia) sp. or Rheum species. In a most particular embodiment, the extract is derived from Reynoutria sachalinensis.

Anthraquinone derivatives can be extracted from plant materials by any inorganic or organic solvents, some of which are allowed to use by National Organic Programs (www.ams.usda.gov/AMSv1.0/nop).

For example, these materials can be ground and then extracted with a base solution, then acidified by an acid solution and finally extracted by organic solvents such as ethyl acetate, butanol; or ground materials can be directly extracted with organic solvents such as ethanol, or ethyl acetate; or any other method and their combination to extract anthraquinone derivatives from plant materials. The extraction solution is then concentrated or dried under vacuum with an appropriate temperature such as 20-100° C., preferred to 30-70° C.

### Lignin

The term “lignin” as used herein refers to a complex polymeric compound found in woody plants, trees, and agricultural crops. Lignins are typically produced as a co-product of the paper industry, separated from trees by a chemical pulping process. However, any plant source (e.g., hard wood lignin, soft wood lignin, grass lignin, straw lignin, and bamboo lignin), nut source (e.g., pecan shell, walnut shell, peanut shell, etc. as a fine powder), seed source (e.g., cotton seed shell as a fine powder), and the like can be used to obtain lignins suitable for use in the compositions and methods herein disclosed.

Examples of lignins that can be obtained from plants, trees, and/or agricultural crops include, but are not limited to, alkali lignins such as Kraft lignins (sulfate lignins), sodium or potassium salts of lignins, or soda lignins; lignin sulphonates (sulfite lignins); oxylignins; chlorolignins; protolignins; lignin liquors obtained directly from the pulping process; salts thereof in liquid or solid form; derivatives thereof; and combinations thereof. Lignins can be obtained from the Kraft pulping process and are generally not water-soluble. Sodium or potassium salts of lignins are generally water-soluble and may even be in liquid form.

In a preferred embodiment, the lignin used is a lignin sulphonate and may also be referred to as lignosulfonate, lignosulfonates, lignosulphonates, lignosulfate, ligninsulfonic acid, lignosulfonic acid, lignosulphuric acid, or LST 7. Lignin sulphonates are to be understood as water soluble anionic polymers which can be formed as by-products in the sulphite pulping process. Lignin sulphonates have generally a wide molecular weight distribution, typically in the range of about 500 to about 150,000. Lignin sulfonates may comprise different metal or ammonium ions as counter cations of the sulfonate groups, e.g. copper, zinc, calcium, sodium, potassium, magnesium, aluminum, et al. In a particular embodiment, lignin sulfonates may be liquid salts obtained after recovery from calcium lignin extraction.

### Formulations

The formulations may be in solid or liquid form. The preparation containing anthraquinone derivatives may be an extract derived from for example, Reynoutria sachalinensis and may be in the form of a emulsifiable concentrate (EC), suspension concentration (SC), microemulsion (ME), nanoemulsion (NE), soluble liquid (SL), emulsion in water (EW), ready-to-use (RTU) and microencapsulate or nano-encapsulate formulation. Powder and granule formulations include but are not limited to water soluble powder (WSP), water dispersible granules (WDG) and water dispersible tablet (WGT). The lignin may in a preferred embodiment may be a lignin sulphonate salt in the form of a water soluble powder or in liquid form.

In particular embodiment, the percent concentration of the preparation containing anthraquinone derivatives in the formulations set forth herein follows a range of between about 0.01 to 95% (v/v). The concentration is preferably between about 0.01% to about 10% (v/v) and most preferably between about 0.5% to about 1% v/v. The percent concentration of the lignin in the formulation set forth herein follows a range of 10% to about 40% v/v.

In a more particular embodiment, the ratio of (a) the preparation comprising one or more anthraquinone derivatives having activity against plant pests to (b) lignin is between about 1:10 to about 10:1 by weight. In yet a more particular embodiment, the ratio of (a) the preparation comprising one or more anthraquinone derivatives having activity against plant pests to (b) lignin is between about 1:1 to about 1:4 by weight. In particular, a liquid formulation contains a ratio of 1:4 of (a) the preparation comprising one or more anthraquinone derivatives having activity against plant pests to (b) lignin. Alternatively, a solid formulation contains a ratio of 1:1 of (a) the preparation comprising one or more anthraquinone derivatives having activity against plant pests to (b) lignin.

The formulation may be an aqueous formulation. The formulation may be diluted between about 100 to about 2500 fold. In a more particular embodiment, the formulation may be diluted between about 100 to about 200 fold.

The formulation may further comprise an antimicrobial agent, such as sodium benzoate, a sorbate or paraben in the range of about 0.1-5% by volume.

The preferred method of applying the formulation is a foliar application (spraying, atomizing, dusting, scattering or pouring) with or without a carrier. The number of applications and the rate of application depend on the risk of infestation by a pathogen generally in a 7-14 day interval. The formulation may also be applied to seeds by impregnating the seeds either with a liquid formulation containing the active ingredient or coating them with a solid formulation. In other cases, further types of application are also possible. These include soil drench, application by drip irrigation or selective treatment of seeds, or plant stems, or buds, or fruits.

### Seed Coating Agent

The formulations set forth above can also be used in combination seed-coating agents. Such seed coating agents include, but are not limited to, ethylene glycol, polyethylene glycol, chitosan, carboxymethyl chitosan, peat moss, resins and waxes or chemical fungicides or bactericides with either single site, multisite or unknown mode of action.

### Plant Growth Promoting Agents

The formulations set forth above can be used in combination with other growth promoting agents such as synthetic or organic fertilizers (e.g., di-ammonium phosphate in either granular or liquid form), compost teas, seaweed extracts, plant growth hormones such as IAA (indole acetic acid) used in a rooting hormone treatment for transplants either alone or in combination with plant growth regulators such as IBA (indole butyric acid) and NAA (naphthalene acetic acid), and, growth promoting microbes, such as Bacillus spp., Pseudomonads, Rhizobia, Trichoderma.

### Anti-Phytopathogenic Agents

The formulations set forth above can also be used in combination with other anti-phytopathogenic agents, such as plant extracts, biopesticides, inorganic crop protectants (such as copper), surfactants (such as rhamnolipids; Gandhi et al., 2007) or natural oils such as paraffinic oil and tea tree oil possessing pesticidal properties or chemical fungicides or bactericides with either single site, multisite or unknown mode of action. As defined herein, an “anti-phytopathogenic agent” is an agent that modulates the growth of a plant pathogen, particularly a pathogen causing soil-borne disease on a plant or alternatively prevents infection of a plant by a plant pathogen. A plant pathogen includes but is not limited to a fungus, bacteria, actinomycete or virus.

As noted above, the anti-phytopathogenic agent may be a single-site anti-fungal agent which may include but is not limited to benzimidazole, a demethylation inhibitor (DMI) (e.g., imidazole, piperazine, pyrimidine, triazole), morpholine, hydroxypyrimidine, anilinopyrimidine, phosphorothiolate, quinone outside inhibitor, quinoline, dicarboximide, carboximide, phenylamide, anilinopyrimidine, phenylpyrrole, aromatic hydrocarbon, cinnamic acid, hydroxyanilide, antibiotic, polyoxin, acylamine, phthalimide, benzenoid (xylylalanine). In a more particular embodiment, the antifungal agent is a demethylation inhibitor selected from the group consisting of imidazole, piperazine, pyrimidine and triazole (e.g., bitertanol, myclobutanil, penconazole, propiconazole, triadimefon, bromuconazole, cyproconazole, diniconazole, fenbuconazole, hexaconazole, tebuconazole, tetraconazole). In a most particular embodiment, the antifungal agent is myclobutanil. In yet another particular embodiment, the antifungal agent is a quinone outside inhibitor (e.g., strobilurin). The strobilurin may include but is not limited to azoxystrobin, kresoxim-methyl or trifloxystrobin. In yet another particular embodiment, the anti-fungal agent is a quinone, e.g., quinoxyfen (5,7-dichloro-4-quinolyl 4-fluorophenyl ether).

In yet a further embodiment, the fungicide is a multi-site non-inorganic, chemical fungicide selected from the group consisting of chloronitrile, quinoxaline, sulphamide, phosphonate, phosphite, dithiocarbamate, chloralkythios, phenylpyridine-amine, cyano-acetamide oxime.

In yet a further embodiment, the anti-phytopathogenic agent may be streptomycin, tetracycline, oxytetracycline, copper, kasugamycin.

### EXAMPLES

The following examples are further illustrative of the present invention. The components and specific ingredients are presented as being typical, and various modifications can be derived in view of the foregoing disclosure within the scope of the invention.

Said compositions detailed here prevent fungus or bacterial infection of plants better than compositions of knotweed that did not use the lignin sulphonate.

### Example I

### Preparation of Formulation

This Example illustrates the preparation of a fungicide spray solution liquid concentrate A blend of the following ingredients is prepared: Five Parts of dried ethanol extract of knotweed is combined with 20 parts of a dried sodium lignin sulfonate and blended in inverting cylinder mixer for a period of no less than 5 minutes. The blended dry mixture is combined with 75 parts deionized water with gentle agitation until uniform.

### Example II

### Efficacy of Formulation Water Soluble Powder (WSP) in Controlling Cucumber Powdery Mildew

Cucumber cv. “SMR 58” was grown in a greenhouse until one to two true leaf stage and are ready to be used for test. There were 4 replications per treatment and each treatment was sprayed 3 ml per plant. After the plants were left to dry, they were inoculated with conidia suspension of Sphaerotheca fuliginea at 3.5×10⁵ spores/ml. Conidia suspension was sprayed at 2 ml per plant. Treatments were arranged in a randomized complete block design and treated plants were incubated at 25-30° C. in greenhouse. Disease severity was rated 7 days post inoculation. Data were analyzed with ANOVA and means were separated with Tukey test at p=0.05 level. The results are shown in Table I.

TABLE I

| | Severity | | Tukey | % |
|---|---|---|---|---|
| Treatment | (%, mean) | S.D. | Grouping | Control |
| Water control | 100.0 | 0.0 | a | 0.0 |
| Reynoutria sachalinensis | 0.3 | 0.6 | c | 99.7 |
| extract + lignin WSP 1:100 | | | | |
| Reynoutria sachalinensis | 0.3 | 0.6 | c | 99.7 |
| extract + lignin WSP 1:200 | | | | |
| Reynoutria sachalinensis | 38.3 | 49.3 | bc | 61.7 |
| extract + lignin WSP 1:1500 | | | | |
| Reynoutria sachalinensis | 62.5 | 31.8 | ab | 37.5 |
| extract + lignin WSP 1:3000 | | | | |
| Lignin blank 1:100 | 100 | 0.0 | a | 0.0 |

p = 0.0003

The newly formulated Reynoutria sachalinensis with lignin preparation showed significant efficacy compared to the water control (p=0.0003) in controlling cucumber powdery mildew, while the blank formulation did not show efficacy. The lignin preparation contained 1% sodium benzoate (antimicrobial agent).

### Example III

### Comparison of the Efficacy of Reynoutria sachalinensis Extract+Lignin New Formulation WSP and Reynoutria sachalinensis Extract 5% ME (Microemulsion) in Controlling Cucumber Powdery Mildew

The plants were grown as described above. There were 4 replications per treatment and each treatment was sprayed with 3 ml of formulation per plant. After the plants were left to dry, they were inoculated with conidia suspension at 2.3×10⁵spores/ml. Conidia suspension was sprayed at 2 ml per plant and incubated at 25-30° C. in a greenhouse.

Disease severity was rated 8 days post inoculation. Data were analyzed with ANOVA and means were separated with Tukey test at p=0.05 level. As shown in Table II below, this formulation showed better efficacy than the current 5% ME formulation:

TABLE II

| | | Severity | | | |
|---|---|---|---|---|---|
| | | (%, | | Tukey | % |
| Trt# | Treatment | mean) | SD | Grouping | Control |
| 1 | Water control | 100.0 | 0.0 | a | 0.0 |
| 2 | Reynoutria sachalinensis | 4.3 | 4.3 | d | 95.8 |
| | extract + lignin WSP | | | | |
| | 1:200 | | | | |
| 6 | Reynoutria sachalinensis | 2.0 | 2.0 | d | 98.0 |
| | extract 5% ME 1:200 | | | | |
| 3 | Reynoutria sachalinensis | 21.5 | 22.9 | dc | 78.5 |
| | extract + lignin WSP | | | | |
| | 1:500 | | | | |
| 7 | Reynoutria sachalinensis | 60.0 | 24.5 | abc | 40.0 |
| | extract 5% ME 1:500 | | | | |
| 4 | Reynoutria sachalinensis | 41.3 | 13.1 | bcd | 58.8 |
| | extract + lignin WSP | | | | |
| | 1:1500 | | | | |
| 8 | Reynoutria sachalinensis | 83.8 | 26.3 | ab | 16.3 |
| | extract 5% ME 1:1500 | | | | |
| 5 | Reynoutria sachalinensis | 63.8 | 42.3 | abc | 36.3 |
| | extract + lignin WSP | | | | |
| | 1:2500 | | | | |
| 9 | Reynoutria sachalinensis | 91.25 | 8.5 | a | 8.8 |
| | extract 5% ME 1:2500 | | | | |

p < 0.0001

### Example IV

### Efficacy of Reynoutria sachalinensis Extract+Lignin New Formulations WSP and Water Dispersible Granules (WDG) in Controlling Cucumber Powdery Mildew

Five batches of plant extract from different extraction lots were used for formulating water soluble powder (WSP) and water dispersible granules (WDG). The test plants were grown as described above. There were 4 replications per treatment and each treatment was sprayed with 3 ml of formulated product per plant. After the plants were left to dry, they were inoculated with conidia suspension at 2.9×10⁵ spores/ml. Conidia suspension was sprayed at 2 ml per plant and incubated at 25-30° C. in a greenhouse. Disease severity was rated 10 days post inoculation. Data were analyzed with ANOVA and means were separated with Tukey test at p=0.05 level. Test results are shown in Table III.

TABLE III

| | Severity | Tukey | % |
|---|---|---|---|
| Treatment | (%) | Grouping | Control |
| Water control | 100.0 | a | 0.0 |
| Reynoutria sachalinensis | 4.0 | b | 96.0 |
| extract + lignin WSP lot | | | |
| 90A 1.2 g/L | | | |
| Reynoutria sachalinensis | 3.3 | b | 96.7 |
| extract + lignin WSP lot | | | |
| 90B 1.2 g/L | | | |
| Reynoutria sachalinensis | 2.0 | b | 98.0 |
| extract + lignin WSP lot | | | |
| 90C 1.2 g/L | | | |
| Reynoutria sachalinensis | 1.0 | b | 99.0 |
| extract + lignin WSP lot | | | |
| 90D 1.2 g/L | | | |
| Reynoutria sachalinensis | 5.3 | b | 94.7 |
| extract + lignin WSP lot | | | |
| 90E 1.2 g/L | | | |
| Reynoutria sachalinensis | 2.0 | b | 98.0 |
| extract + lignin WDG lot | | | |
| 90F 1.2 g/L | | | |
| Reynoutria sachalinensis | 1.0 | b | 99.0 |
| extract + lignin WDG lot | | | |
| 90G 1.2 g/L | | | |
| Reynoutria sachalinensis | 0.8 | b | 99.2 |
| extract + lignin WDG lot | | | |
| 90H 1.2 g/L | | | |
| Reynoutria sachalinensis | 3.0 | b | 97.0 |
| extract + lignin WDG lot | | | |
| 90I 1.2 g/L | | | |
| Reynoutria sachalinensis | 5.3 | b | 94.7 |
| extract + lignin WDG 90J | | | |
| 1.2 g/L | | | |

p < 0.0001

The newly formulated Reynoutria sachalinensis extract with lignin preparation as WSP and WDG all showed significant efficacy compared to the water control (p<0.0001) in controlling cucumber powdery mildew.

### Example V

### Efficacy of Reynoutria sachalinensis Extract+Lignin New Formulation WSP of Different Rates and New Formulation WDG Label Rate in Controlling Cucumber Powdery Mildew

Three rates of formulated Reynoutria sachalinensis extract as WSP were compared to the current formulation Reynoutria sachalinensis extract 20% ME at the same rates and the lower label rate of extract as WDG were also evaluated for their efficacy in controlling cucumber powdery mildew. The test procedure was described as in Examples II to IV. There were 4 replications per treatment and 3 ml of each treatment was applied per plant. After the treatments dried up the plants were inoculated with conidia suspension of 3.6×10⁵ spores/ml at 2 ml per plant. The inoculated plants were incubated at 25-30° C. in greenhouse. Disease severity was rated 7 days post inoculation. Data were analyzed as mentioned in Examples II to IV. Test results are shown in Table IV.

TABLE IV

| | Severity | Tukey | % |
|---|---|---|---|
| Treatment | (%) | Grouping | Control |
| Water control | 95.0 | a | 0.0 |
| Reynoutria sachalinensis | 42.5 | bc | 55.3 |
| extract 20% ME 1:1600 | | | |
| Reynoutria sachalinensis | 10.0 | cd | 89.5 |
| extract 20% ME1:3200 | | | |
| Reynoutria sachalinensis | 62.5 | bc | 34.2 |
| extract 20% ME 1:6400 | | | |
| Reynoutria sachalinensis | 0.0 | d | 100.0 |
| extract + lignin WSP 1:1600 | | | |
| Reynoutria sachalinensis | 2.0 | d | 97.9 |
| extract + lignin WSP 1:3200 | | | |
| Reynoutria sachalinensis | 57.5 | bc | 39.5 |
| extract + lignin WSP 1:6400 | | | |
| Reynoutria sachalinensis | 0.0 | d | 100.0 |
| extract + lignin WDG 1:800 | | | |

p < 0.0001

The Reynoutria sachalinensis extract formulated as WSP showed better or similar efficacy with less variation compared to current formulate product Reynoutria sachalinensis extract 20% ME. The extract formulated as WDG also had significant better disease control than the water check.

### Example VI

### Efficacy of Reynoutria sachalinensis Extract+Lignin New Formulations WSP and WDG in Controlling Phytophthora capsici on Tomato Plants

Reynoutria sachalinensis extract was formulated as WSP and as WDG. Both formulations were evaluated for their efficacy in controlling Phytophthora leaf blight on tomato. The cv “Roma” was planted in greenhouse till two true leaf stage. The isolate of P. capsici was grown on lima bean media (150 g lima bean was autoclaved in 500 ml water at 121° C. for 0.5 h and filtered through two layers of cheese cloth to remove seed coats. 20 g of agar was added to the filtrate and increase the volume to 1000 ml. The media was autoclaved at 121° C. for 15 min) for 7 days and the sporangia were washed off with sterile water. The sporangia suspension was incubated at room temperature (about 25° C.) for 1-2 h to release zoospores. The suspension was adjusted to 1.0×10⁵ spores/ml.

There were three single plant replications per treatments. For each treatment, 3 ml treatment/plant was applied with hand held sprayer. After the treatments dried up in a container for incubation, 10 ml of spore suspension was applied uniformly onto all the plants. The container was sealed to maintain high moisture and the plants were incubated at 25° C. in darkness for 3 days. Disease was rated 7 days post inoculation. Results are shown in Table V. As shown in Table V, the formulated Reynoutria sachalinensis extract with lignin preparation showed similar efficacy compared to the current 20% ME formulation in controlling Phytophthora blight and had reduced disease severity compared to the water control. It has been found surprisingly that a mixture of dried plant extract from Reynoutria sachalinensis and dried extracts of sulfonated wood pulp (also known as lignin sulfonates) forms a physically and chemically stable powder that mixes easily and in many proportions with water to create a sprayable solution that when applied to growing plants prevents infection of fungi.

TABLE V

| | Severity | Tukey | % |
|---|---|---|---|
| Treatment | (%, mean) | Grouping | Control |
| Water control | 56.7 | a | 0.0 |
| Reynoutria sachalinensis | 21.7 | ab | 61.7 |
| extract 20% ME 1:800 | | | |
| Reynoutria sachalinensis | 20.0 | ab | 64.7 |
| extract + lignin WSP 1:800 | | | |
| Reynoutria sachalinensis | 28.3 | Ab | 50.1 |
| extract + lignin WDG 1:800 | | | |
| mefenoxam (Ridomil) 1.24 g/L | 2.3 | b | 95.9 |

(p = 0.0485)

Although this invention has been described with reference to specific embodiments, the details thereof are not to be construed as limiting, as it is obvious that one can use various equivalents, changes and modifications and still be within the scope of the present invention.

Various references are cited throughout this specification, each of which is incorporated herein by reference in its entirety.

### Literature Cited

Daayf, F., A. Schmitt, et al. (1995). “The effects of plant extracts of Reynoutria sachalinensis on powdery mildew development and leaf physiology of long English cucumber.” Plant Disease 79: 577-580.
Durrant, W. E. and X. Dong (2004). “Systemic acquired resistance.” Annual Review of Phytopathology 42: 185-209.
Kuc, J., (2000). Development and future direction of induced systemic resistance in plants, Crop Protection 19: 859-861.
Schmitt, A. (2002). “Induced responses by plant extracts from Reynoutria sachalinensis: a case study.” Bull. IOBC/WPRS 25: 83-89.
van Loon, L. E., Bakker, P. A. H. M. and Pieterse, S C. M. J. (1998) “Systemic resistance induced by Rhizosphere bacteria”, Annu. Rev. Phytopathol. 36:453-83.
V\check{e}chet, L., L. Burketova, et al. (2009). “A comparative study of the efficiency of several sources of induced resistance to powdery mildew (Blumeria graminis f. sp. tritici) in wheat under field conditions.” Crop Protection 28: 151-154.
Wurms, K., C. Labbe, et al. (1999). “Effects of Milsana and Benzothiadiazole on the ultrastructure of powdery mildew haustoria in cucumber.” Phytopathology 89: 728-736.

What is claimed is:

1. A formulation comprising (a) a preparation comprising one or more anthraquinone derivatives having activity against plant pests and (b) a lignin.

2. The formulation according to claim 1, wherein said preparation comprising one or more anthraquinone derivatives having activity against plant pests is an extract derived from the family Polygonaceae, Rhamnaceae, Fabaceae, Asphodelaceae, and Rubiaceae.

3. The formulation according claim 1, wherein said preparation comprising one or more anthraquinone derivatives having activity against plant pests is an extract derived from Reynoutria sachalinensis.

4. The formulation according to claim 1, wherein said anthraquinone derivative has the structure 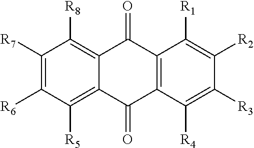
Where R1, R2, R3, R4, R5, R6, R7 and R8 are hydrogen, hydroxyl, hydroxylalkyl, halogen, carboxyl, alkyl, alkyoxyl, alkenyl, alkenyloxyl, alkynyl, alkynyloxyl, heterocyclyl, aromatic, or aryl group or sugars.

5. The formulation according to claim 1, wherein said anthraquinone derivative is selected from the group consisting of physcion, emodin, chrysophanol, ventiloquinone, emodin glycoside, chrysophanol glycoside, physcion glycoside, 3, 4-dihydroxy-1-methoxy anthraquinone-2-carboxaldehyde and damnacanthal.

6. The formulation according to claim 1, wherein said lignin is an alkali lignin, a lignosulphonate, an oxylignin; a chlorolignin; a protolignin; a lignin liquor or salts or derivatives thereof.

7. The formulation according to claim 1, wherein said lignin is a lignosulphonate or salt thereof.

8. The formulation according to claim 7, wherein said lignosulphonate is a sodium, potassium, lithium, calcium, magnesium or ammonium salt of lignosulphonate.

9. The formulation according to claim 1, wherein the ratio of (a) the preparation comprising one or more anthraquinone derivatives having activity against plant pests to (b) lignin is between about 1:10 to about 10:1 by weight.

10. The formulation according to claim 1, wherein the ratio of (a) the preparation comprising one or more anthraquinone derivatives having activity against plant pests to (b) lignin is between about 1:1 to about 1:4 by weight.

11. The formulation according to claim 1, wherein said formulation is an aqueous formulation.

12. The formulation according to claim 1, wherein said formulation is in the form of a water dispersible granule.

13. The formulation according to claim 1, wherein said formulation is in the form of water soluble powder.

14. A method of producing the formulation of claim 1 comprising mixing (a) a preparation comprising one or more anthraquinone derivatives having activity against plant pests with (b) a lignin and optionally (c) water.

15. The method according to claim 14, wherein about 1 part of (a) a preparation comprising one or more anthraquinone derivatives having activity against plant pests is mixed with (b) about 1 to about 9 parts of a lignin to obtain a dry formulation.

16. A method for producing an aqueous formulation comprising (a) a preparation comprising one or more anthraquinone derivatives having activity against plant pests and (b) a lignin comprising mixing about 1 part of a dry formulation obtained according to the method of claim 9 with about 100 to about 2500 parts of water.

17. A method for modulating phytopathogenic, fungal and/or bacterial infection and/or plant pest infestation in a plant comprising applying to the plant and/or seeds thereof and/or substrate used for growing said plant an amount of the formulation of claim 1 effective to modulate said phytopathogenic, fungal and/or bacterial infection and/or plant pest infestation.

18. A method for modulating germination of a seed of a plant comprising applying to said seed an amount of the formulation of claim 1 and optionally a seed coating agent effective to modulate said germination of said seed of said plant.

19. A method for modulating growth of a plant comprising treating said plant with an amount of the formulation of claim 1 effective to modulate said growth in said plant.
